(19) United States
(12) Patent Application Publication
(10) Pub. No.: US 2010/0005497 A1
(43) Pub. Date: Jan. 7, 2010

(54) Duplex enhanced quality video transmission over internet

(76) Inventor: Michael Maresca, Woodcliff Lakes, NJ (US)

Correspondence Address: ABELMAN, FRAYNE & SCHWAB, 666 THIRD AVENUE, 10TH FLOOR, NEW YORK, NY, 10017, US

(21) Appl. No.: 12/217,270

(22) Filed: Jul. 1, 2008

(51) Int. Cl. H04N 7/173

(52) U.S. Cl. 725/109

(57) ABSTRACT

A system for sending and receiving full motion, live, full duplex video of broadcast quality, with associated audio data, over the Internet. The system comprises software that ties together audio and video packets and transmits them as a smooth continuous stream of video and audio data. The system is capable of functioning over a secure peer-to-peer backbone.

### BACKGROUND OF THE INVENTION

1. Field of the Invention

This invention relates to the transmission of data over communication links and, in particular, to the transmission of full duplex, full motion, live video over the Internet.

2. Description of the Related Art

The use of existing hardwired communications networks to transmit video as well as voice communications is well known, and has been practiced for several decades. However, prior art systems have typically been very expensive, or have had limitations such as only allowing transmission of images with noticeable delays, poor transmission quality, or both. Full motion video, and especially interactive video, requires the delivery of a very significant amount of data in a relatively uninterrupted stream, which has proven difficult to accomplish over existing telephonic and computer networks.

Integrated Services Digital Network (ISDN) lines have been used for video transmission, with some success, as disclosed in publications such as U.S. Pat. No. 5,371,534, No. 5,751,339, and No. 5,184,345. While this has resulted in much improved transmission quality, the expense of ISDN lines remains a formidable obstacle to their wide use.

An alternative to the transmission of video data over ISDN lines is the use of standard twisted pair copper wire telephone lines, or via the Internet or other computer networks. A viable solution using existing telephone networks was achieved by the Applicant previously, and is protected by U.S. Pat. No. 6,181,693, issued Jan. 30, 2001.

A solution using the Internet or other computer networks to deliver full-motion, live, full duplex transmission of broadcast or near broadcast quality video has been unsolved until now. The Internet relies on grouping the data to be transmitted over it into small component packages of data called packets. These packets are, in general, of unequal length and contain information to indicate where they begin and end, as well as source and destination information. Packets from diverse sources travel over the Internet together and, thus must be recognized at any intermediate switching point and at their final destination points for recombination with other properly associated packets, if successful transmission is to occur. The packeting methodology by its very nature leads to potential delays in transmission and processing, and a degradation in the quality of the transmission. In addition, the ever growing number of users on the Internet has compounded the delay in transmission. Such delays and degradation in quality, although generally not critical in voice communications or in unidirectional video communications, are less tolerable in applications requiring a high data transmission rate such as full-motion, live, full duplex video transmission, particularly if broadcast quality or near broadcast quality video is required. By and large, bidirectional video communication has suffered from both severe latency as well as poor image quality.

The present invention enables the Internet or other computer network to be used to deliver full-motion, live, full duplex transmission of broadcast or near broadcast quality video. The benefits from the wide implementation of this technology are almost too innumerable to recount. Among its benefits are the vast expansion of both commercial and recreational use of the video telephone and the creation of a new level of interactive television and telephonic video communications. The potential uses span almost all fields of endeavor, including, for example, the entertainment industry, the financial services industry, the field of corporate communications, hotel and travel services, governmental agency and public services applications, medical services, educational services, and an almost endless variety of consumer applications.

In the field of entertainment, for example, television viewers could participate visually and interactively with not only the host of a program, but other viewers as well. Entirely new television broadcast programming formats will become possible. Television news programs could create video chat rooms and solicit immediate viewer reaction to news as it occurs. News organizations could link their vast network of affiliates together to cover news as it happens using their combined resources. Programs directly marketing products or services would be enhanced by the ability of viewers to interact by video as well as by voice with the marketer and other customers.

Inexpensive video conferencing, particularly given the security available with a secure client peer-to-peer connection, is compatible with the needs of many industries, such as the financial services industry, which in the past has had justifiable concerns about transmitting information over the Internet. Moreover, the present practice of business and financial community conference call reporting to the investment community can be greatly enhanced by providing video as well as audio interactivity among participants. In the hotel and travel industry, the availability of video transmission and reception at hotels enhances the services available to a business traveler who is enabled to maintain constant interactive point-to-point contact with home, office, and other business associates.

In general, private industry will, if it chooses, have the ready availability to create relatively inexpensively its own closed circuit television network, without the attendant costs of ISDN and T1 lines. Interactive communication between government agencies also has obvious significant advantages, particularly in emergency situations, and the advantages in the medical field of ready accessible visual communication and interactivity for patient diagnosis, monitoring, and the proliferation of services and knowledge between care givers, patients and hospitals is also self-evident. As well, the advantages in the field of education are significant, ranging from video tutoring and “wide area” classrooms to budget reduction as information is offered from a central location with the students enabled to maintain a personal, visual interaction with the instructor.

However, the most obvious beneficiaries of the present invention are individuals who, with the availability of a means to capture video, can, through the use of the present invention, employ an Internet connection to communicate with another person or a group of others, in broadcast or near-broadcast quality video.

The foregoing examples are in no way intended to be exhaustive, and many other benefits stemming from the present invention will be obvious to those of ordinary skill in the art.

### SUMMARY OF THE INVENTION

The present invention comprises means for capturing video images and associated audio, packeting the same, transmitting them as a smooth continuous stream of video and audio data over the Internet, decoupling the data laden packets, and reassembling the data as video images with associated audio at the desired recipient location. In an alternative embodiment, the present invention also permits a combination of the images from diverse locations, so that there is not only interactivity between a single sender and receiver, but, as well, with multiple parties.

To accomplish the duplex enhanced quality transmission of the video and audio data between source(s) and destination(s), the present invention is capable of functioning over a secure peer-to-peer backbone.

In its simplest form, a user has at his or her location a means to capture video imagery and the associated audio and convert it to a digital signal, and a means to convert a received digital signal into a presentation of video imagery and the associated audio. These means are generally well-known in the art and would include devices such as a microphone, a camera, a video/audio encoder/decoder, a monitor, and a speaker. In general the means are either integral in or can be made available by employing a personal computer (“PC”). In accordance with the present invention, the transmitted or received video signal is transmitted to or received from the Internet in packets of predetermined, preferably equal length. Each packet is generally encoded with the following information: (1) information indicating the beginning and the end of the packet, (2) information indicating the length of the packet, (3) information indicating the algorithm used to encode the audio/video data, and (4) the encoded audio/video data itself.

Thus, even before the audio/video data leaves the location of the sender, it has been transformed into packets to be transmitted over the Internet or other computer network, and the audio/video data remains in packet form until it arrives at the location of the receiver.

The packet stream is routed to the recipient who has the apparatus, software or both designed in accordance with the present invention to capture the data and convert the packets to an audio/video signal which is in turn displayed on a video device with accompanying audio projected. This generally is a PC.

Since the transmission and reception of the packets is based on a first in/first out protocol, as packets are pulled out to be transmitted or received, they are immediately replaced with the next packets required to be transmitted or received. As a consequence, the sequence is maintained in a relatively uninterrupted manner. Although it is indeed preferable to transmit and receive all data without any error, the system of the present invention need not transmit and receive 100% of the data since an acceptable, indeed very high quality video signal will be enabled even with a loss of some data from the stream of data.

The present invention thus provides for the transmission and reception of full motion, full duplex, live video data and accompanying audio data over the Internet or other computer network, with the concomitant benefit of permitting parties at remote locations to visually and audibly communicate with each other. As well, if one of the parties to the connection is a television studio originating a video broadcast, the video communications received will be and can be transmitted and received between any two points served by the conventional telephone network, at a cost which does not deter widespread use.

This is accomplished through the use of a preferential Internet backbone, a preferential route supplied by arrangement with a data network provider, using fiberoptic lines that are carrying reduced data traffic. This provides for great bandwidth for the bidirectional transmission of video between two or more users.

When an authorized user logs on, a Network Operation Center (“NOC”) verifies both the user and the other users authorized to receive video from and send video to each other. The NOC provides applicable addresses of other users to which each user may connect. If there are only two users, the system will place them into a peer-to-peer connection, for enhanced speed, reliability, and security.

In an additional embodiment, where more than two users are to be connected, the system creates a meeting room, a virtual location where the users of the system “meet.” By use of a multiplexing system the NOC permits all users to have the same transmission rates of data and as more specifically described permits certain supplementary enhancements, such as featuring a larger image of the person then speaking.

In an additional embodiment, a room system may also connect to the videoconference system. A room system is a videoconferencing station that typically includes large monitors with a wide-angle camera and serves groups of people who meet in a room and conference with other groups at remote locations. If the room system has an Internet connection, it would connect to the videoconference system in a manner similar to that used by a personal computer. In such a case, if there was only one other user, the connection would be peer-to-peer, whereas if there were three or more total users, the connection would be made through a meeting room at the NOC. If the room system does not have an Internet connection, but instead has a private network, then it would connect to the NOC through a hardware bridge.

These and other objects and advantages of the present invention will become more apparent to those of ordinary skill in the art upon consideration of the attached drawings and the following description of the preferred embodiments which are meant by way of illustration and example only, but are not to be construed as in any way limiting the invention disclosed and claimed herein.

### BRIEF DESCRIPTION OF THE DRAWINGS

Further advantages and features of the present invention will become apparent from the detailed description of a preferred embodiment of the invention with reference to the accompanying drawings, in which:

FIG. 1 is a schematic diagram showing an embodiment of the bidirectional transmission of video between two users, where each is using a personal computer via an Internet path.

FIG. 2 is a schematic diagram showing an embodiment of the bidirectional transmission of video between two users, where one is using a personal computer with an Internet connection and the other is using a room system with a private network.

FIG. 3 is a schematic diagram showing an embodiment of the bidirectional transmission of video between three or more users, where each user accesses a meeting room.

### DETAILED DESCRIPTION OF THE INVENTION

The present invention is a system for duplex enhanced quality bidirectional video transmission over an Internet backbone. Among the improvements in the duplex enhanced quality video transmission system of the present invention is better performance while eliminating the need for specialized hardware.

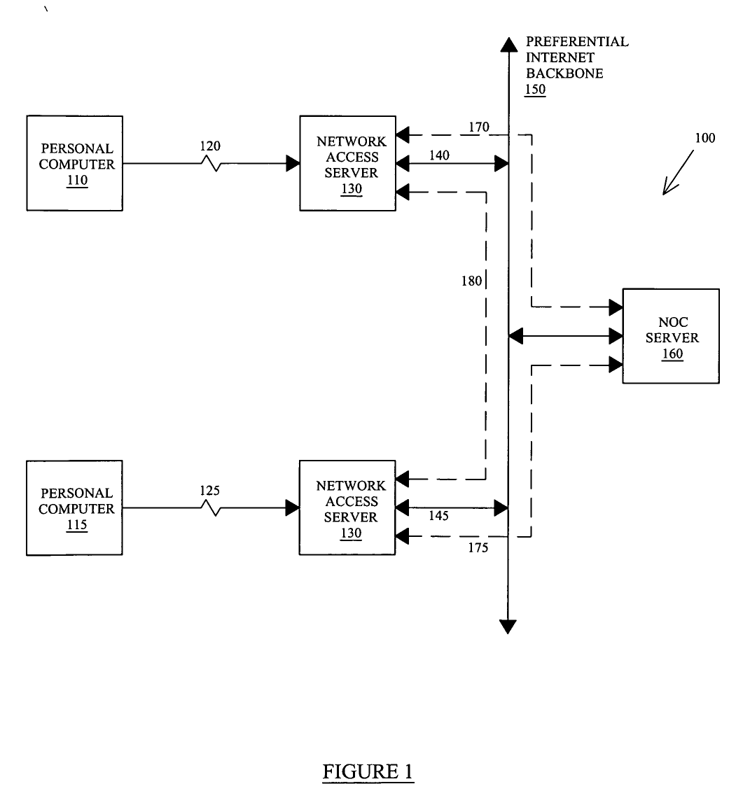

FIG. 1 shows an implementation of a system 100 featuring bidirectional transmission of video between two users, with each using a personal computer via an Internet path. Generally, the system 100 includes: personal computers 110 and 115; a network access server 130; a network operation center (“NOC”) server 160; and an Internet network 150.

Personal computer 110 may be a desktop computer, laptop, workstation or router, that is capable of connecting into the network access server 130 to establish a session 120. Personal computer 110 incorporates a secure client desktop software containing a computer network authentication protocol employing strong encryption, preferably IPsec. This Internet security protocol allows for cryptographic key establishment and authenticating and/or encrypting each IP packet in a data stream. IPsec or other like protocol is preferable because it functions at the network layer, which gives it more flexibility than many other security protocols in common use, such as SSH, SSL/TL and Kerberos, which operate on the transport layer. This difference allows IPsec to secure packet flows.

The secure client connects to a website hosted by network access server 130, where the user's identity is confirmed. The network access server 130 is a computer, or a group of hardware or software components or processes that execute in one or more computer systems.

The secure client and network access server 130 then create an encrypted network tunnel from the user's computer to a Network Operation Center (“NOC”) server 160, via a private Internet backbone 150. This preferential Internet backbone 150 is a preferential route supplied by arrangement with a data network provider, using fiberoptic lines that are reserved to carry specially routed traffic, thus providing for greater available bandwidth for the bidirectional transmission of video between two or more users of the system.

The network access server 130 controls remote access to the preferential Internet backbone 150 and to the NOC server 160, along route 170, forwarding the password that has been supplied by the user at personal computer 110 to the network access server 130.

The NOC server 160 is a computer, or a group of hardware or software components or processes that execute in one or more computer systems. In part, the NOC server 160 performs authorization and authentication functions. The NOC server 160 has a directory established for each user, containing identification and password information and a list of approved users to whom each user may connect. The NOC server 160 utilizes the password forwarded by the network access server 130 to perform After authorizing and authenticating the user at personal computer 110, the NOC server 160 presents the user with the list of approved users to whom he can connect. For each approved user appearing in a contact list, the NOC server 160 also shows whether that user is online or not. As well, given the mobility of computers, the NOC server locates the initiating user as well as the addressee.

For example, the user at personal computer 110 wishes to communicate with the user at personal computer 115, but that user is not online. The user at personal computer 110 needs to contact the user at personal computer 115, via telephone, e-mail, text message, etc., and request that he sign into the system. The user at personal computer 115 goes through the identical process of connecting into the network access server 130 so as to establish his own session 125, and likewise being connected to the NOC server 160 via a preferential Internet backbone 150, along route 175. Once the personal computer 115 is online, the user at personal computer 110 will be able to request a bidirectional video session with personal computer 115. In one embodiment, the user at personal computer 115 must manually accept the bidirectional video session, whereas in a second embodiment, personal computer 115 may be set to an auto-answer mode, where the bidirectional video session will be established upon the request from personal computer 110.

The NOC server 160 will then communicate instructions to personal computer 110 along route 170, and to personal computer 115 along route 175, providing each with a virtual address of the other. At this point, the secure clients in personal computers 110 and personal computers 115 will initiate a peer-to-peer connection over the preferential Internet backbone 150, along route 180. Personal computers 110 and 115 will exchange bidirectional video in this peer-to-peer mode along route 180. The personal computers 110 and 115 will remain in contact with the NOC server 160 along routes 170 and 175, respectively, so that the NOC server 160 may continue to provide control functions, but the video stream will not be sent to the NOC server 160. Eliminating the need to pass the video and audio data through the NOC server 160 provides for enhanced performance and security.

Instead of a personal computer, a user may use a room system, which is a videoconferencing station that typically includes large monitors with a wide-angle camera and serves groups of people who meet in a room and conference with other groups at remote locations. If the room system has an Internet connection, it would interface to the videoconferencing system in the manner of Personal Computer 115.

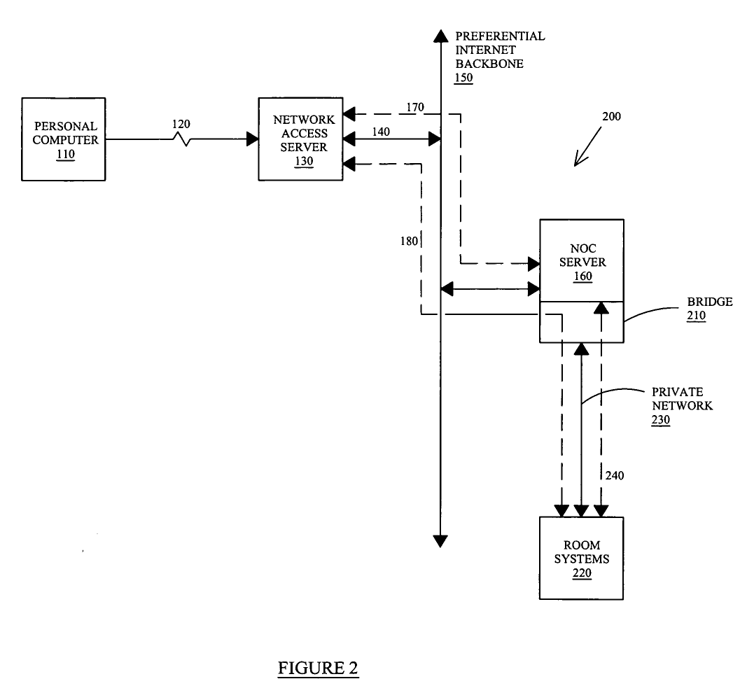

FIG. 2 shows an implementation in which one of the users is using a room system 220 which instead of having an Internet connection has a private network 230. The privately networked room system 220 connects to the NOC server 160 through a hardware bridge 210. The room system 220 communicates with the NOC server 160 along route 240, allowing for the NOC server 160 to perform the authorization and authentication functions. The bridge 210 also serves as a conduit for the video signals, as they travel along path 180 between personal computer 110 and the room system 220. As path 180 is routed partially on the preferential Internet backbone 150 and partially on the private network 230, a high bandwidth is available, resulting in excellent image quality and reduced latency. As well, the NOC can provide enhanced video and audio exchange capabilities by providing features such as automated or individually directed control room activities. For example, all users' images can be arranged around an enlarged central image provided for the speaker or a desired illustration.

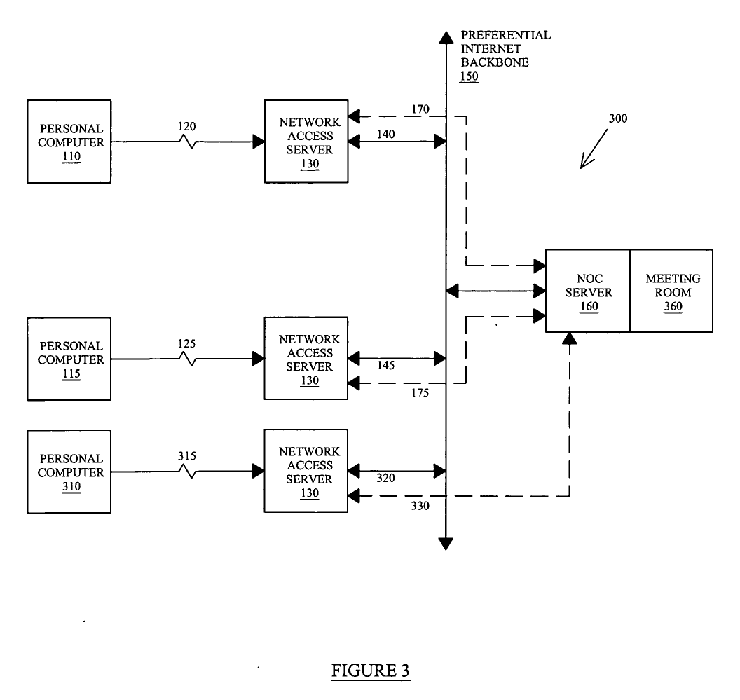

FIG. 3 shows another implementation, in which three or more users are participating in a videoconference. In this situation, the users log into a meeting room 360 which is provided at the NOC server 160. The meeting room 360 multiplexes each incoming video signal, and sends a copy to the other participants. Each participant will see each other participant in the video conference call, providing for enhanced security, as no one may monitor a video conference unless they are a participant and their presence is seen by all other participants. One or more of the participants in a videoconference with three or more participants may be employing a room system with a private network that interfaces to the invention through a hardware bridge located at the NOC server, as previously described and shown in FIG. 2.

In another embodiment, the secure client can be tailored for a particular application or industry, such as having the video only take up part of the screen, with the remainder of the screen dedicated to another task, such as displaying a user-completed form.

In the foregoing specification, the present invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A system for sending over the Internet audio/video data from one first location, and receiving over the Internet a reproduction of said first audio/video data at a second location, and sending over the Internet audio/video data from said second location, and receiving over the Internet a reproduction of said second audio/video data at said first location, said system comprising:
a. a means for converting said first audio/video data in said first location into a first stream of packets to be sent over the Internet;
b. a means for converting said second audio/video data in said second location into a second stream of packets to be sent over the Internet;
c. a means for converting said first stream of packets in said second location into said reproduction of said first audio/video data to be presented in said second location;
d. a means for converting said second stream of packets in said first location into said reproduction of said second audio/video data to be presented in said first location;
e. a means for allowing said first location and said second location to exchange said first stream of packets and said second stream of packets over a preferential Internet backbone,
said system being capable of sending said first audio/video data and said second audio/video data and receiving said reproduction of said first audio/video data and said reproduction of said second audio/video data in a full duplex, full motion, and live manner.

2. The system of claim 1,
a. wherein said means for converting said first and second audio/video data comprises:
i. an audio/video encoder/decoder producing an audio/video encoder output data stream;
ii. a packetizer accepting a processed form of said audio/video encoder output data stream after processing of said audio/video encoder output data stream between said audio/video encoder/decoder and said packetizer, said packetizer producing a stream of unbuffered packets; and
iii. a modem accepting said first and second streams of packets and sending said first and second streams of packets over said Internet, said first and second streams of packets being produced by buffering of said stream of unbuffered packets, and
b. wherein said means for converting said first and second stream of packets comprises:
i. a modem receiving said first and second streams of packets from the Internet; and
ii. an audio/video encoder/decoder receiving an audio/video decoder input data stream from said modem after processing of said first and second streams of packets between said modem and said audio/video encoder/decoder.

3. The system of claim 1, wherein said first and second streams of packets are transmitted over said preferential Internet backbone in a peer-to-peer mode between said first location and said second location.

4. The system of claim 2, wherein said first and second streams of packets are transmitted over said preferential Internet backbone in a peer-to-peer mode between said first location and said second location.

5. The system of claim 3, wherein said means for allowing said first location and said second location to exchange said first stream of packets and said second stream of packets over a preferential Internet backbone, comprises a network access server which allows said first and second locations to access said preferential Internet backbone, and thereby access a NOC server, which is adapted to perform authorization and authentication functions upon being accessed by an authorized user at each location, and which contains a database for those functions, said database also containing a list of at least one other authorized user that a particular authorized user may contact for a videoconference,
said NOC server passing virtual address information between said first and second locations, allowing said first and second locations to thereafter communicate in a peer-to-peer mode over said preferential Internet backbone, without said first and second streams of packets passing through said NOC server.

6. The system of claim 4, wherein said means for allowing said first location and said second location to exchange said first stream of packets and said second stream of packets over a preferential Internet backbone, comprises a network access server which allows said first and second locations to access said preferential Internet backbone, and thereby access a NOC server,
which performs authorization and authentication functions upon being accessed by an authorized user at each location, and which contains a database for those functions, said database also containing a list of each user that a particular authorized user may contact for a videoconference,
said NOC server passing virtual address information between said first and second locations, allowing said first and second locations to thereafter communicate in said peer-to-peer mode over said preferential Internet backbone, without said first and second streams of packets passing through said NOC server.

7. A system for sending over the Internet audio/video data from one first location, and receiving over a private network a reproduction of said first audio/video data at a second location, and sending over a private network audio/video data from said second location, and receiving over the Internet a reproduction of said second audio/video data at said first location, said system comprising:
a. a means for converting said first audio/video data in said first location into a first stream of packets to be sent over the Internet;
b. a means for converting said second audio/video data in said second location into a second stream of packets to be sent over the private network;
c. a means for converting said first stream of packets in said second location into said reproduction of said first audio/video data to be presented in said second location;
d. a means for converting said second stream of packets in said first location into said reproduction of said second audio/video data to be presented in said first location;
e. a means for allowing said first location and said second location to exchange said first stream of packets and said second stream of packets via the Internet and the private network,
wherein the exchange of the streams of packets via the Internet is conducted over a preferential Internet backbone,
said system being capable of sending said first audio/video data and said second audio/video data and receiving said reproduction of said first audio/video data and said reproduction of said second audio/video data in a full duplex, full motion, and live manner.

8. The system of claim 7, wherein the second location is a room system with a private network, which communicates with a NOC server through a hardware bridge,
wherein said NOC server is adapted to perform authorization and authentication functions upon being accessed by an authorized user at each location, and which contains a database for those functions, said database also containing a list of at least one other authorized user that a particular authorized user may contact for a videoconference,
said NOC server functioning as said means for allowing said first location and said second location to exchange said first stream of packets and said second stream of packets.

9. A system for sending over the Internet audio/video data from three or more locations, and receiving over the Internet at each location a reproduction of audio/video data from each other location, said system comprising:
a. a means for converting said audio/video data in each location into a stream of packets to be sent over the Internet;
b. a means for allowing said three or more locations to transmit streams of packets over a preferential Internet backbone, wherein said means comprises a network access server which allows said three or more locations to access said preferential Internet backbone, and thereby access a NOC server,
which said NOC server is adapted to perform authorization and authentication functions upon being accessed by an authorized user at each location, and which contains a database for those functions, said database also containing a list of at least one other authorized user that a particular authorized user may contact for a videoconference,
said NOC server creating a virtual meeting room in which said three or more locations may conduct a videoconference, with the NOC server multiplexing audio/video data from each of the three or more locations, and preparing for each location a stream of packets comprising a presentation of the audio/video data from each other location;
d. a means for transmitting from the NOC to each location said stream of packets comprising a presentation of the audio/video data from each other location;
e. a means for converting at each location said stream of packets comprising a presentation of the audio/video data from each other location into a reproduction of said presentation of said audio/video data from each other location;
f. said system being capable of sending said audio/video data from each location and receiving said reproduction of said presentation of said audio/video data from each other location in a full duplex, full motion, and live manner.

10. A system for sharing audio/video data from three or more locations,
with one or more locations connected to the Internet, and with one or more locations connected to a private network, each sending its associated audio/video data to every other location, and receiving a reproduction of audio/video data from every other location, said system comprising:
a. a means for converting said audio/video data in each location into a stream of packets;
b. a means for transmitting said stream of packets from said one or more locations connected to the Internet via a preferential Internet backbone, wherein said means comprises a network access server which allows said one or more locations connected to the Internet to access said preferential Internet backbone, and thereby access a NOC server;
c. a means for transmitting said stream of packets from said one or more locations connected to a private network, wherein said private network communicates with the NOC server via a hardware bridge;
d. said NOC server being adapted to perform authorization and authentication functions upon being accessed by an authorized user at each location, and which contains a database for those functions, said database also containing a list of at least one other authorized user that a particular authorized user may contact for a videoconference,
said NOC server creating a virtual meeting room in which said three or more locations may conduct a videoconference, with the NOC server multiplexing audio/video data from each of the three or more locations, and preparing for each location a stream of packets comprising a presentation of the audio/video data from each other location;
e. a means for transmitting from the NOC to each location said stream of packets comprising a presentation of the audio/video data from each other location;
f. a means for converting at each location said stream of packets comprising a presentation of the audio/video data from each other location into a reproduction of the presentation of the audio/video data from each other location;
g. said system being capable of sending said audio/video data from each location and receiving said reproduction of said audio/video data from each other location in a full duplex, full motion, and live manner.

11. The system of claim 9, wherein the presentation of the audio/video data from each other location includes an enlarged image of the video data from one of said each other locations.

12. The system of claim 10, wherein the presentation of the audio/video data from each other location includes an enlarged image of the video data from one of said each other locations.

13. The system of claim 11, wherein the system selects the video data for the enlarged image from one of said each other locations when a user at that location begins to speak.

14. The system of claim 12, wherein the system selects the video data for the enlarged image from one of said each other locations when a user at that location begins to speak.
